(19) United States
(12) Patent Application Publication
(10) Pub. No.: US 2022/0118549 A1
(43) Pub. Date: Apr. 21, 2022

(54) DYNAMIC ENERGY AND SPOT SIZE ADJUSTMENT METHOD FOR LASER PROCESSING WITH OPTICAL MICROSCOPE

(71) Applicant: ACME MICROSYSTEM INC., New Taipei City (TW)

(72) Inventors: Hung Chieh YU, New Taipei City (TW); Chen-Jung LI, New Taipei City (TW)

(73) Assignee: ACME MICROSYSTEM INC., New Taipei City (TW)

(21) Appl. No.: 17/076,464

(22) Filed: Oct. 21, 2020

(51) Int. Cl. B23K 26/06; G02B 26/10; G02B 21/00

(52) U.S. Cl. CPC B23K 26/0648; G02B 21/0048; G02B 21/0028; G02B 26/105

(57) ABSTRACT

The dynamic energy and spot size adjustment method for laser processing with an optical microscope is applied to a laser processing machine which includes a console, a calculation module, a laser source, a beam adjustment unit, a galvanometer scanner, a light sensor, a vision module, an F-theta lens, a beam splitter, and an objective lens. The laser source generates a laser beam passing through the beam adjustment unit to form a laser processing beam which further passes through the galvanometer scanner, the F-theta lens, the beam splitter, and the objective lens to focus on a working plane. The beam splitter respectively guides parts of the laser processing beam to the vision module and the light sensor. The vision module and the light sensor cooperate with the calculation module to identify/measure and record the energy and spot size of the laser processing beam as dynamic adjustment references during laser processing.

### BACKGROUND OF THE INVENTION

### 1. Field of the Invention

The present invention relates to an adjustment method for laser processing, particularly to a dynamic energy and spot size adjustment method for laser processing with an optical microscope.

### 2. Description of the Related Art

Nowadays, laser (light amplification by stimulated emission of radiation) processing such as laser marking, laser surface treatment and laser cutting have been very popular. Laser processing can be used for many materials and objects that are difficult to process by other processing methods, for example, diamond molds, nozzles for chemical fiber industry, etc. A laser beam can be focused by optical lenses to form a tiny spot on the surface of the irradiated material to achieve very fine processing. In addition, the energy, moving speed, and spot size of the laser beam can be incorporated with optical equipment, computers, CNC machine tools, and automatic detection technology/equipment to realize automated processing.

The scanning movement of a laser beam on an object is usually achieved through a galvanometer scanner. The galvanometer scanner generally has two reflecting mirrors to control a reflected output direction of an incident laser beam by successively reflecting the incident laser beam via the two reflecting mirrors. By respectively controlling the individual reflecting angles of the two reflecting mirrors, the galvanometer scanner is capable of guiding the incident laser beam to scan on a two-dimensional working plane.

However, the above-mentioned laser processing still has some shortcomings to be resolved.

1. When using a galvanometer scanner, scanning at different scanning positions results in different energies. When the galvanometer scanner changes the scanning angles, the laser beam landed at various positions through mirrors or lenses will experience different degrees of mirror reflectivity and different lens thickness, so the laser beam energy received at the object end will also differ.

2. Unstable laser output energy may occur in continuous laser operations; hence the laser output energy will inevitably fluctuate during continuous processing.

3. When using a galvanometer scanner, scanning in different scanning positions results in different spot sizes. Hence when the galvanometer scanner changes the scanning angles, the spot size of the laser beam will inevitably differ at the object end, and thereby the processing area of the laser beam on the object surface will be different.

4. The spot size changes due to external factors during continuous processing because the spot size may be deformed by the surface conditions of the processed sample.

According to the afore-mentioned, the conventional laser processing must be further improved.

### SUMMARY OF THE INVENTION

In view of the above-mentioned problems in the conventional laser processing, the present invention provides a dynamic energy adjustment method for laser processing with an optical microscope, which is applied to a laser processing machine and the laser processing machine includes a console, a calculation module, a galvanometer scanner, a light sensor, a beam splitter, a laser source generating a laser beam, and a beam adjustment unit which further includes an optical attenuator for attenuating the laser beam passing through the beam adjustment unit to form a laser processing beam. After the laser processing beam passes through the galvanometer scanner and the beam splitter, the laser processing beam is focused on a plane; the laser processing beam is controlled to scan the plane via the galvanometer scanner which is further controlled by the console and the calculation module, and the beam splitter guides a part of the laser processing beam to the light sensor for measuring the energy of the laser processing beam. The dynamic energy adjustment method for laser processing with an optical microscope includes the steps:

step s5: sample placement, wherein a sample is placed on the plane;

step s7: obtaining an energy reference value from energy relationship curve database, wherein the calculation module reads an energy relationship curve database to obtain the energy reference value;

step s8: various positions processing, wherein based on a target processing position and the energy relationship curve database, the calculation module finds the energy of the laser processing beam corresponding to the target processing position, and uses said energy as the energy reference value of the laser processing beam at the target processing position, and then based on a target processing energy for the target processing position and the energy reference value corresponding to the target processing position, the calculation module determines the output energy of the laser source or the attenuation value of the optical attenuator, and then a group of control commands are issued to control the console which controls the output energy of the laser source or the attenuation value of the optical attenuator to adjust the energy of the laser processing beam for the target processing position;

step s9: real time measuring processing energy, wherein the light sensor measures the processing energy signal of the laser processing beam in real time, and transmits the measured processing energy signal to the calculation module to obtain the energy of the laser processing beam in real time;

step s10: comparing measured value and reference value, wherein the calculation module compares and confirms whether a relative percentage difference between the energy of the laser processing beam measured in real time and the energy reference value of the energy relationship curve database is greater than a first threshold; when said relative percentage difference is greater than the first threshold, go to the next step; otherwise skip the next step and go to the further next step;

step s11: real time energy adjustment, wherein real time energy adjustment is performed on the laser processing beam based on the energy reference value from the energy relationship curve database.

In one embodiment, the dynamic energy adjustment method for laser processing with an optical microscope further includes the steps:

step s2: initial state measurement, wherein the energy of the laser processing beam at each of multiple test positions is measured by the light sensor and recorded by the calculation module;

step s3: calculating the energy relationship curve between galvanometer scanner's reflection angles and energy, wherein the correspondence between the energy of the laser processing beam measured in step s2 and two corresponding reflection angles of the galvanometer scanner defines the energy relationship curve;

step s4: storing energy reference values at various positions to the database, wherein the energy of the laser processing beam and the two corresponding reflection angles of the galvanometer scanner in step s3 are stored to an energy relationship curve database.

In one embodiment, the multiple test positions landed by the laser processing beam are 17 test positions located within a scanning range of the galvanometer scanner, and the 17 test positions include a center point, eight inner loop points, and eight outer loop points.

In one embodiment, the galvanometer scanner includes a first scanning mirror and a second scanning mirror; the two reflection angles of the galvanometer scanner are a first reflection angle of the first scanning mirror and a second reflection angle of the second scanning mirror; and the first reflection angle and the second reflection angle are controlled by the console and the calculation module.

In one embodiment, the formula is as follows:

E_{S}=E*a*cos θ_{X}*b*cos θ_{Y}

where a and b are weights calculated by using θ_{X} as the difference between the corresponding first reflection angle of the center point and the corresponding first reflection angle of each of the eight outer loop points or the eight inner loop points respectively, and by using θ_{Y} as the difference between the corresponding second reflection angle of the center point 19 and the corresponding second reflection angle of each of the eight outer loop points or the eight inner loop points respectively.

In one embodiment, the laser processing machine further includes an objective lens, and the laser processing beam continuously passes through the beam splitter and the objective lens.

In one embodiment, the laser processing machine further includes an F-theta lens, and the laser processing beam continuously passes through the galvanometer scanner and the F-theta lens.

At the same time, in view of the above-mentioned problems in the conventional laser processing, the present invention also provides a dynamic spot size adjustment method for laser processing with an optical microscope, which is applied to a laser processing machine. The laser processing machine includes a console, a calculation module, a galvanometer scanner, a vision module, a beam splitter, a laser source generating a laser beam, and a beam adjustment unit which further includes a beam expander for expanding the laser beam passing through the beam adjustment unit to form a laser processing beam, wherein after the laser processing beam passes through the galvanometer scanner and the beam splitter, the laser processing beam is focused on a plane; and the laser processing beam is controlled to scan the plane via the galvanometer scanner which is further controlled by the console and the calculation module, and the beam splitter guides a reflected laser processing beam to the vision module for measuring the spot size of the laser processing beam. The dynamic spot size adjustment method for laser processing with optical microscope includes the steps:

step s25: sample placement, wherein the sample is placed on the plane;

step s27: obtaining a spot size reference value from database, wherein the calculation module reads a spot size relationship curve database;

step s28: various positions processing, wherein, based on a target processing position and the spot size relationship curve database, the calculation module finds the spot size of the laser processing beam corresponding to the target processing position, and uses said spot size as the spot size reference value of the laser processing beam at the target processing position, and then based on a target processing spot size for the target processing position and the spot size reference value corresponding to the target processing position, the calculation module determines an expansion value of the beam expander, and then issues a group of control commands to control the console, and then controls the expansion value of the beam expander via the console to adjust the spot size of the laser processing beam;

step s29: real time measuring laser processing beam spot size, wherein the vision module senses the spot size image of the laser processing beam in real time, and thereby the calculation module determines the spot size of the laser processing beam in real time;

step s30: comparing measured value and reference value, wherein the calculation module compares and confirms whether a relative percentage difference between the spot size of the laser processing beam measured in real time and the spot size reference value of the spot size relationship curve database is greater than a second threshold, and when said relative percentage difference is greater than the second threshold, go to the next step; otherwise skip the next step and go to the further next step;

step s31: real time spot size adjustment, wherein real time spot size adjustment is performed on the laser processing beam based on the spot size reference value from the spot size relationship curve database;

step s32: finish processing, wherein the laser processing is completed.

In one embodiment, the dynamic spot size adjustment method for laser processing with an optical microscope further includes the steps:

step s22: initial state measurement, wherein the spot size of the laser processing beam at each of multiple test positions is sensed by the vision module, and then recognized, measured, and recorded by the calculation module;

step s23: calculating the spot size relationship curve between the galvanometer scanner's reflection angles and spot size, wherein the correspondence between the spot size measured in step s22 and two reflection angles of the galvanometer scanner defines the spot size relationship curve;

step s24: storing spot size reference values at various positions to the database, wherein the spot size of the laser processing beam and the two corresponding reflection angles of the galvanometer scanner in step s23 are stored to a spot size relationship curve database.

In one embodiment, the multiple test positions landed by the laser processing beam are 17 test positions located within a scanning range of the galvanometer scanner, and the 17 test positions include a center point, eight inner loop points, and eight outer loop points.

In one embodiment, the galvanometer scanner includes a first scanning mirror and a second scanning mirror; the two reflection angles of the galvanometer scanner are a first reflection angle of the first scanning mirror and a second reflection angle of the second scanning mirror; and the first reflection angle and the second reflection angle are controlled by the console and the calculation module.

In one embodiment, the laser processing machine further includes an objective lens, and the laser processing beam continuously passes through the beam splitter and the objective lens.

In one embodiment, the laser processing machine further includes an F-theta lens, and the laser processing beam continuously passes through the galvanometer scanner and the F-theta lens.

### BRIEF DESCRIPTION OF THE DRAWINGS

FIG. 1 is a schematic view of the laser processing machine of the present invention;

FIG. 2A is a schematic view of the 17-points test positions in the present invention;

FIG. 2B is a schematic view of the first reflection angle difference and the second reflection angle difference in various positions with respect to a center point in the present invention;

FIG. 3 is a flowchart of the method of the present invention;

FIG. 4 is a flowchart of the method of the present invention;

FIG. 5 is a schematic view of the first system architecture of the present invention;

FIG. 6 is a schematic view of the second system architecture of the present invention; and

FIG. 7 is a schematic view of the third system architecture of the present invention.

### DETAILED DESCRIPTION OF THE INVENTION

In the following, the technical solutions in the embodiments of the present invention will be clearly and fully described with reference to the drawings in the embodiments of the present invention. Obviously, the described embodiments are only a part of the embodiments of the present invention, but not all the embodiments. Based on the embodiments of the present invention, all other embodiments obtained by a person of ordinary skill in the art without creative efforts shall fall within the protection scope of the present invention.

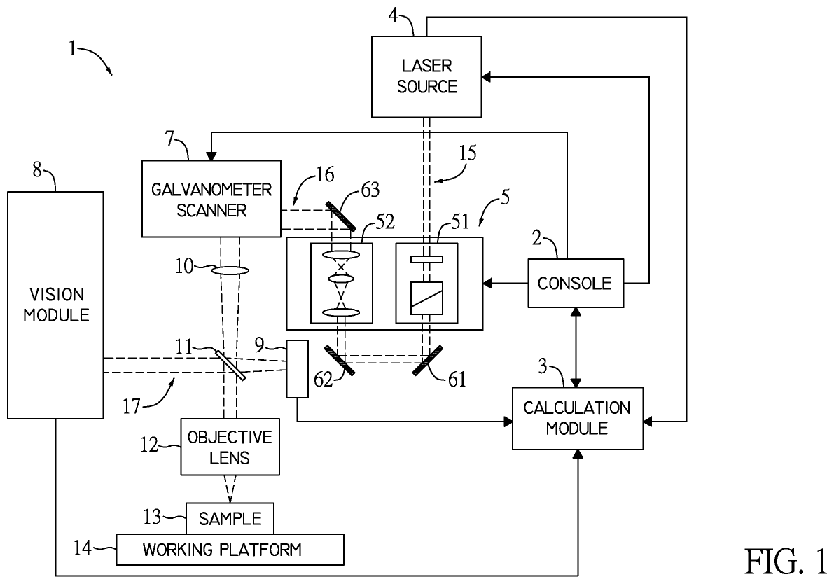

Referring to FIG. 1, a laser processing machine 1 comprises a console 2, a calculation module 3, a laser source 4, a beam adjustment unit 5, a first reflector 61, a second reflector 62, a third reflector 63, a galvanometer scanner 7, a vision module 8, a light sensor 9, an F-theta lens 10, a beam splitter 11, an objective lens 12, and a working platform 14.

The laser source 4 is configured to generate a laser beam 15 and to transmit an output energy signal of the laser beam 15 to the calculation module 3. The beam adjustment unit 5 is configured to receive and to adjust the laser beam 15 to be a laser processing beam 16. The galvanometer scanner 7 has a first scanning mirror and a second scanning mirror (not shown in the figures), and is configured to successively reflect an incoming laser processing beam 16, wherein the first scanning mirror and the second scanning mirror each respectively have a first reflection angle and a second reflection angle (not shown in the figures) which can be controlled to continuously reflect the incoming laser processing beam 16 to sequentially scan on a two-dimensional plane. For the laser processing beam 16 landing on the two-dimensional plane, its spot size and energy density (i.e. energy per unit area) will vary with respect to the first reflection angle and the second reflection angle. In other words, for the laser processing beam 16 landing on the two-dimensional plane, its spot size and energy density will vary with respect to its landing position.

The F-theta lens 10 has a flat image plane for a monochromatic light, and for an incident light beam with a fixed deflection speed, the scanning speed of an output light beam is also fixed on the flat image plane, so the output light beam can be linearly scanned on the image plane with an incident light beam at a constant angular velocity. The above-mentioned laser processing beam 16 continuously reflected by the galvanometer scanner 7 will then pass through the F-theta lens 10, and thus a linear scanning of the laser processing beam 16 on a plane can be realized accordingly. After passing through the F-theta lens 10, the laser processing beam 16 will then pass through the beam splitter 11, and the beam splitter 11 will reflect approximately 1% of the energy in the laser processing beam 16 to the light sensor 9. The light sensor 9 converts the received laser processing beam 16 into a processing energy signal, and transmits the processing energy signal to the calculation module 3.

As mentioned above, besides said laser processing beam 16 reflected by the beam splitter 11, about 99% of the laser processing beam 16 remaining will then pass through the objective lens 12 which is configured to focus the laser beam 16. Then, the laser processing beam 16 is focused on the surface of the sample 13 which is placed on the working platform 14. At this time, the laser processing beam 16 can start processing the surface of the sample 13, and a reflected laser processing beam 17 is also generated from the surface of the sample 13. The reflected laser processing beam 17 will enter and pass through the objective lens 12, and then get reflected by the beam splitter 11 to reach the vision module 8.

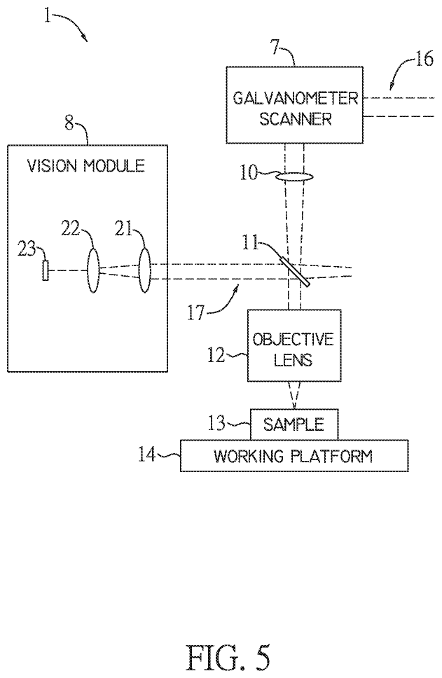

As shown in FIG. 5, the vision module 8 is an optical microscope with an image sensor 23 such as a charge coupled device (CCD) or a CMOS image sensor (CIS). The vision module 8 receives the split light reflected by the beam splitter 11 from the reflected laser processing beam 17 to generate an image signal of the surface of the sample 13 accordingly, and then the image signal is transmitted to the calculation module 3 to determine whether the sample's position is within the scanning range of the laser processing beam 16, and whether the laser processing beam 16 has accurately landed on a target processing position on the surface of the sample 13. The spot size formed on the surface of the sample 13 by the laser processing beam 16 can be observed and measured as well.

The beam adjustment unit 5 further comprises an optical attenuator 51 and a beam expander 52. The optical attenuator 51 allows the laser beam 15 to pass through and to controllably attenuate the energy of the laser beam 15 according to an attenuation value, and then the attenuated laser beam 15 is reflected successively by the first reflector 61 and the second reflector 62, which guide the attenuated laser beam 15 to the beam expander 52. The beam expander 52 allows the attenuated laser beam 15 to pass through to controllably adjust the spot size of the attenuated laser beam 15 according to an expansion value so as to obtain a laser processing beam 16, and then the laser processing beam 16 is guided to the galvanometer scanner 7 by the third reflector 63.

The calculation module 3 is electrically connected to the laser source 4, the vision module 8, the light sensor 9, and the console 2, and the calculation module 3 is configured to receive the output energy signal of the laser source 4, the image signal of the vision module 8, and the processing energy signal of the light sensor 9. The calculation module 3 further includes an algorithm which is based on a target surface position of the processed sample 13 and an energy density requirement corresponding to the target surface position. The output energy signal, the image signal, and the processing energy signal received by the calculation module 3 are calculated according to the algorithm to obtain a group of control commands to control the output energy of the laser source 4, the first reflection angle and the second reflection angle of the galvanometer scanner 7, the attenuation value of the optical attenuator 51, and the expansion value of the beam expander 52. Then the calculation module 3 transmits the group of control commands to the console 2.

The console 2 is electrically connected to the laser source 4, the galvanometer scanner 7, the optical attenuator 51, and the beam expander 52. Based on the group of control commands received from the calculation module 3, the console 2 controls the output energy of the laser source 4, the first reflection angle and the second reflection angle of the galvanometer scanner 7, the attenuation value of the optical attenuator 51, and the expansion value of the beam expander 52, so that the target surface position of the sample 13 can receive the required energy density from the laser processing beam 16.

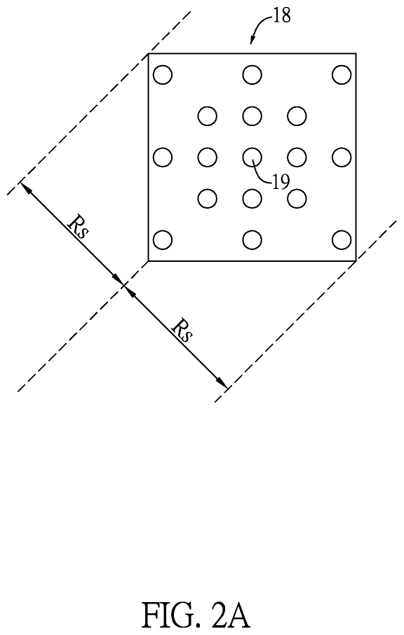

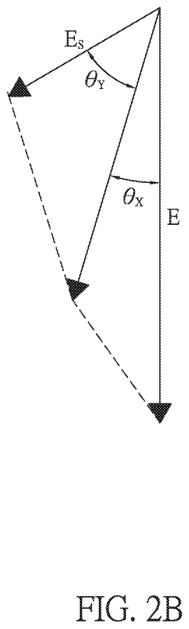

Referring to FIGS. 2A and 2B, a scanning range 18 is defined as a scanning range of the F-theta lens 10, and a radius R_{S} of the scanning range 18 can be defined as a parameter describing the size of the scanning range 18. The scanning range 18 will depend on parameters such as a working distance of the F-theta lens 10 (not shown in figures), a magnification of the objective lens 12 and a light entrance aperture (not shown in figures), and a distance between the light exit of the galvanometer scanner 7 and the objective lens 12 (not shown in figures). In the scanning range 18, seventeen test points (abbreviated as 17-points, hereinafter) can be defined, including the four corners and the midpoints of the four sides of the scanning range 18 (referred to as the eight outer loop points hereinafter) and the center point 19 of the scanning range, and eight points (referred to as the eight inner loop points hereinafter) respectively formed at the midpoints between the eight outer loop points and the center point 19.

FIG. 2B is a schematic view of the first reflection angle difference and the second reflection angle difference in various positions with respect to a center point in the present invention, where E is the energy at the center point 19. Relative to the energy E at the center point 19, the energy E_{S} at each of the eight outer loop points or each of the eight inner loop points is expressed by the formula (1) as follows:

E_{S}=E*a*cos θ_{X}*b*cos θ_{Y} formula (1)

Where a and b are weights to be calculated by using θ_{X} as the difference between the corresponding first reflection angle of the center point 19 and the corresponding first reflection angle of each of the eight outer loop points or the eight inner loop points respectively, and by using θ_{Y} as the difference between the corresponding second reflection angle of the center point 19 and the corresponding second reflection angle of each of the eight outer loop points or the eight inner loop points respectively. Once the values of the weights a and b are calculated, the energy E_{S} at other points in the scanning range can be obtained from formula (1). For FIG. 2B, the values of the weights a and b are both assumed to be 1.

As mentioned above, the energy density at the center point 19 of the scanning range 18 is the energy E of the center point 19 divided by the spot size at the center point 19, and the energy density at each point in the eight outer loop points or the eight inner loop points of the scanning range 18 is respectively the energy E_{S} divided by the corresponding spot size.

In addition, after the image signal sensed by the vision module 8 is transmitted to the calculation module 3, the calculation module 3 can then use an image recognition algorithm to identify the light spot and its spot size in the image signal.

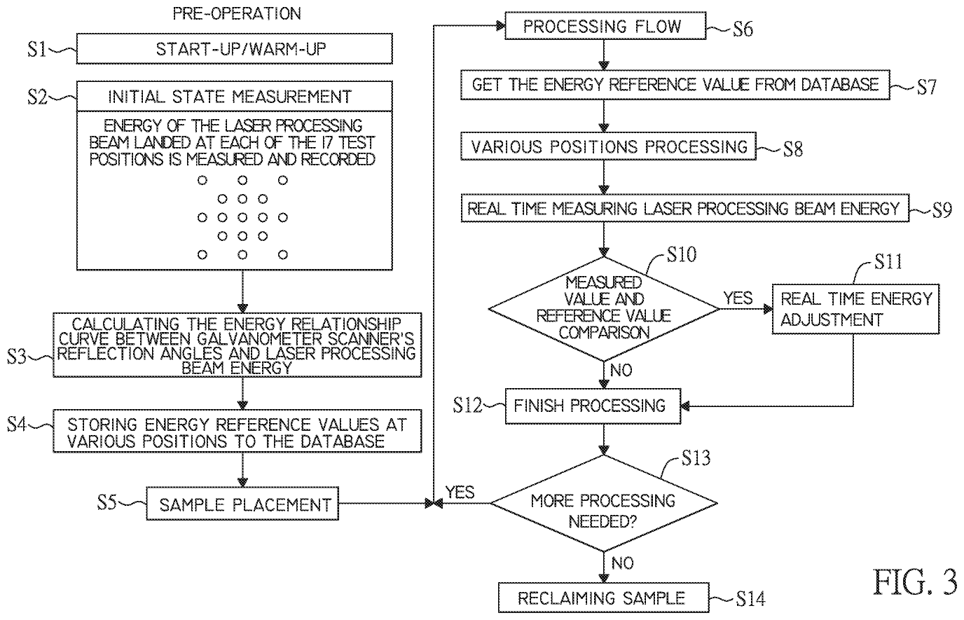

Referring to FIG. 3, the energy dynamic adjustment method has a pre-operation stage which starts from step s1 “start-up/warm-up”, which is to start and warm up the relevant units in the laser processing machine 1, such as the console 2, the calculation module 3, the laser source 4, the optical attenuator 51, the beam expander 52, the galvanometer scanner 7, the vision module 8, the light sensor 9, etc.

Next, the pre-operation stage performs step s2 “initial state measurement”, in which the energy of the laser processing beam 16 at each of the 17-points test positions is measured by the light sensor 9 and recorded by the calculation module 3; that is, the energy of the laser processing beam 16 is recorded after the laser processing beam 16 is successively reflected by the galvanometer scanner's two scanning mirrors at corresponding reflection angles. The calculation module 3 can convert the processing energy signal received by the photo sensor 9 into the energy of the laser processing beam 16 by a ratio. For example, if the processing energy signal is 1% of the energy E of the center point 19 or the energy E_{S} of each of the eight outer loop points and the eight inner loop points, then the processing energy signal can be multiplied by 100 to obtain the energy of the laser processing beam 16.

Next, the pre-operation stage performs step s3 “calculating the energy relationship curve between galvanometer scanner's reflection angles and energy. Based on the processing energy signal measured in step s2 and the two corresponding reflection angles of the galvanometer scanner 7, the calculation module 3 calculates the weights a and b of the formula (1), so the formula (1) defines the relationship curve between the reflection angles of the galvanometer scanner 7 and the laser processing beam energy.

Next, the pre-operation stage performs step s4 “storing energy reference values at various positions to the database”, in which the weights a and b calculated in step s3, the corresponding energy of the laser processing beam i.e., the energy reference value, at various positions, and the corresponding two reflection angles data of the galvanometer scanner are stored in an energy relationship curve database. In response to different requirements and ranges, the energy relationship curve database can be further divided into databases of energy relationship curves of the 17-points with the objective lens and without the objective lens.

Next, the pre-operation stage ends by performing step s5 “sample placement”, in which the sample 13 is appropriately placed on the working platform 14.

Next, enter step s6 “processing flow” and get ready to start processing the sample 13; then enter step s7 “obtaining the energy reference value from database” where the calculation module 3 reads the energy relationship curve database.

Next, enter step s8 “various positions processing” where, based on a target processing position and the energy relationship curve database, the calculation module 3 finds the energy of the laser processing beam corresponding to the target processing position via formula (1), and uses it as the energy reference value of the laser processing beam 16 at the target processing position. Then based on a target processing energy and the energy reference value corresponding to the target processing position, the calculation module 3 appropriately adjusts the output energy of the laser source 4 or the attenuation value of the optical attenuator 51, and then issues the group of control commands to control the console 2, and then the console 2 controls the output energy of the laser source 4 or the attenuation value of the optical attenuator to adjust the energy of the laser processing beam 16, and to process the target processing position with the adjusted laser processing beam 16.

Next, enter step s9 “real time measuring processing energy” wherein the light sensor 9 measures the processing energy signal of the laser processing beam 16 in real time, and transmits the measured processing energy signal to the calculation module 3 in real time to get the energy of the laser processing beam 16.

Next, enter step s10 “comparing measured value and reference value” in which the calculation module 3 compares and confirms whether a relative percentage difference between the energy of the laser processing beam 16 measured in real time and the energy reference value of the energy relationship curve database is greater than a first threshold. When said relative percentage difference is greater than the first threshold, go to the next step; otherwise, skip the next step and go to the further next step.

Next, enter step s11 “real time energy adjustment”, and perform a real time energy adjustment on the laser processing beam 16 based on the energy reference value from the energy relationship curve database.

Next, enter step s12 “finish processing” wherein the current processing is completed; then enter step s13 “confirming whether more processing is needed” where the calculation module 3 will check whether there is more processing needed. When more processing is needed, go back to step s6 “processing flow”; otherwise, go to the next step.

Enter step s14 “retrieving sample” where the processed sample 13 is taken out.

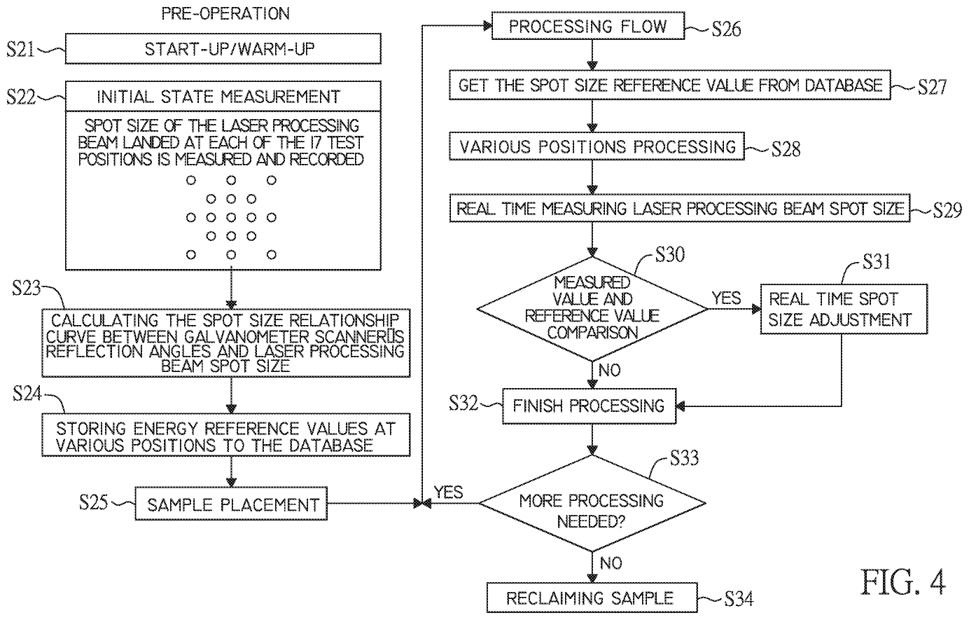

Referring to the flowchart of FIG. 4 depicting the spot size dynamic adjustment method in the present invention, wherein the spot size dynamic adjustment method has a pre-operation stage which starts from step s21 “start-up/warm-up” (please refer to the above-mentioned start-up/warm-up step s1). Next, the pre-operation stage performs step s22 “initial state measurement”, in which the spot size of the laser processing beam 16 at each of the 17-points test positions is sensed by the vision module 8 and then recognized, measured, and recorded by the calculation module 3; that is, the spot size of the laser processing beam 16 is recorded after the laser processing beam 16 is reflected by the galvanometer scanner's two scanning mirrors at corresponding reflection angles.

Next, the pre-operation stage performs step s23 “calculating the spot size relationship curve between the galvanometer scanner's reflection angles and spot size” where the spot size measured in step s22 corresponds to the two reflection angles of the galvanometer scanner 7, and the correspondence between the spot size measured in step s22 and the two reflection angles of the galvanometer scanner 7 defines the spot size relationship curve.

Next, the pre-operation stage performs step s24 “storing spot size reference values at various positions to the database” wherein the spot size and the two corresponding reflection angles data in step s23 “calculating the spot size relationship curve between the galvanometer scanner's reflection angles and spot size” are stored to a spot size relationship curve database, and in response to different requirements and ranges, the spot size relationship curve database can be further divided into databases of spot size relationship curves of the 17-points with the objective lens and without the objective lens.

Next, the pre-operation stage ends by performing step s25 “sample placement” which appropriately places the sample 13 on the working platform 14.

Next, enter step s26 “processing flow” and get ready to start processing the sample 13; then enter step 27 “obtaining the spot size reference value from database” where the calculation module 3 reads the spot size relationship curve database.

Next enter step s28 “various positions processing” wherein based on a target processing position and the spot size relationship curve database, the calculation module 3 finds the spot size of the laser processing beam 16 corresponding to the target processing position via a formula similar to formula (1) but with the energy being replaced by the spot size and the weights a and b being calculated with respect to spot size instead of energy, and uses the spot size found by the calculation module 3 as the spot size reference value of the laser processing beam 16 at the target processing position. Then based on a target spot size and the spot size reference value corresponding to the target processing position, the calculation module 3 appropriately adjusts the expansion value of the beam expander 52, and then issues the group of control commands to control the console 2, and then controls the expansion value of the beam expander 52 via the console 2 to adjust the spot size of the laser processing beam 16, and to process the target processing position with the adjusted laser processing beam 16. Next, enter step s29 “real time measuring laser processing beam spot size” wherein the vision module 8 senses the spot size image of the laser processing beam 16 in real time, and thereby the calculation module 3 determines the spot size of the laser processing beam 16 in real time.

Next, enter step s30 “comparing measured value and reference value” in which the calculation module 3 compares and confirms whether a relative percentage difference between the spot size of the laser processing beam 16 measured in real time and the spot size reference value of the spot size relationship curve database is greater than a second threshold. When said relative percentage difference is greater than the second threshold, go to the next step; otherwise, skip the next step and go to the further next step.

Next, enter step s31 “real time spot size adjustment” and perform real time spot size adjustment on the laser processing beam 16 based on the spot size reference value from the spot size relationship curve database.

Next, enter step s32 “finish processing” to complete the processing; then enter step s33 “confirming whether more processing is needed” where the calculation module 3 will check whether there is more processing needed, and when more processing is needed, go back to the “processing flow” step s26; otherwise, go to the next step.

Enter step s34 “retrieving sample”, where the processed sample 13 is taken out.

Please refer to a schematic view of FIG. 5 depicting the first system architecture of the present invention, wherein the laser processing machine 1 comprises the F-theta lens 10 and the objective lens 12, and the vision module 8 which further comprises an objective lens 21, a tube lens 22, and an image sensor 23. A processing range defined by the image field of the image sensor 23 has a radius R_{P}, and the relationship between the radius R_{P} of the processing range and the radius R_{S} of the scanning range 18 is shown in formula (2):

R_{P}=[200/[200+X*(D_{W}−D₀)]]*R_{S} formula (2)

Where X is the magnification of the objective lens 12, D_{W} is the working distance of the F-theta lens 10, and D₀ is the distance between the F-theta lens 10 and the objective lens 12 of the F-theta lens 10.

When the radius R_{P} of the processing range is greater than or equal to the radius R_{S} of the scanning range 18, the vision module 8 can observe the entire scanning range 18 within its field of view, and when the radius R_{P} of the processing range is smaller than the radius R_{S} of the scanning range 18, the vision module 8 can only observe part of the scanning range 18 within its field of view.

In addition, in one embodiment, the relationship between the magnification X of the objective lens 12 and the radius R_{S} of the scanning range 18 is shown in the following table:

| | without objective | | | | |
|---|---|---|---|---|---|
| X | lens | 5 | 10 | 20 | 50 |
| R_{S} | 25.4 mm | 4.8 mm | 2.4 mm | 1.2 mm | 0.45 mm |

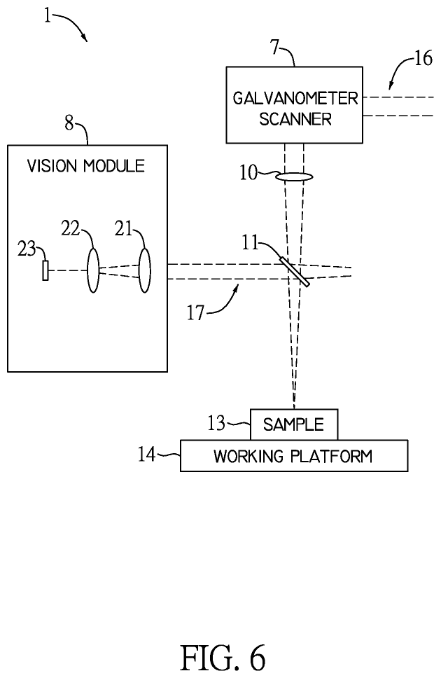

Referring to a schematic view of FIG. 5 depicting the second system architecture of the present invention. By comparing the second system architecture of FIG. 6 with the first system architecture of FIG. 5, we know that the laser processing machine 1 does not have the objective lens 12, and the relationship between the radius R_{P} of the processing range and the radius R_{S} of the scanning range 18 is as shown in formula (3):

R_{P}=R_{S} formula (3)

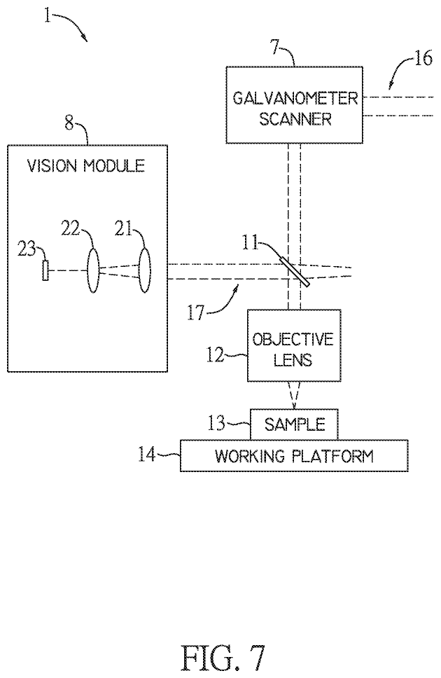

Referring to a schematic view of FIG. 7 depicting the third system architecture of the present invention, by comparing the third system architecture of FIG. 7 with the first system architecture of FIG. 5, we know that the laser processing machine 1 does not have the F-theta lens 10, and the relationship between the radius R_{P} of the processing range and the radius R_{S} of the scanning range 18 is as shown in formula (4):

R_{P}=[1−(X/200)2+X/(200D₀)]*R_{S} formula (4)

The aforementioned are preferred embodiments of the present invention. It should be noted that for those of ordinary skill in the art, without departing from the principles of the present invention, certain improvements and retouches of the present invention can still be made which are nevertheless considered as within the protection scope of the present invention.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A dynamic energy adjustment method for laser processing with an optical microscope, applied to a laser processing machine which includes a console, a calculation module, a galvanometer scanner, a light sensor, a beam splitter, a laser source generating a laser beam, and a beam adjustment unit which further includes an optical attenuator for attenuating the laser beam passing through the beam adjustment unit to form a laser processing beam, wherein after the laser processing beam passes through the galvanometer scanner and the beam splitter, the laser processing beam is focused on a plane; the laser processing beam is controlled to scan the plane via the galvanometer scanner which is further controlled by the console and the calculation module, the beam splitter guides a part of the laser processing beam to the light sensor for measuring the energy of the laser processing beam, and the dynamic energy adjustment method including the steps:
step s5: sample placement, wherein a sample is placed on the plane;
step s7: obtaining an energy reference value from an energy relationship curve database, wherein the calculation module reads an energy relationship curve database to obtain the energy reference value;
step s8: various positions processing, wherein, based on a target processing position and the energy relationship curve database, the calculation module finds the energy of the laser processing beam corresponding to the target processing position, and uses said energy as the energy reference value of the laser processing beam at the target processing position, and then based on a target processing energy for the target processing position and the energy reference value corresponding to the target processing position, the calculation module determines the output energy of the laser source or the attenuation value of the optical attenuator, and then a group of control commands are issued to control the console which controls the output energy of the laser source or the attenuation value of the optical attenuator to adjust the energy of the laser processing beam for the target processing position;
step s9: real time measuring processing energy, wherein the light sensor measures the processing energy signal of the laser processing beam in real time, and transmits the measured processing energy signal to the calculation module to obtain the energy of the laser processing beam in real time;
step s10: comparing measured value and reference value, wherein, the calculation module compares and confirms whether a relative percentage difference between the energy of the laser processing beam measured in real time and the energy reference value of the energy relationship curve database is greater than a first threshold; when said relative percentage difference is greater than the first threshold, go to the next step; otherwise skip the next step and go to the further next step;
step s11: real time energy adjustment, wherein, real time energy adjustment is performed on the laser processing beam based on the energy reference value from the energy relationship curve database.

2. The method as claimed in claim 1, further including the steps:
step s2: initial state measurement, wherein, the energy of the laser processing beam at each of multiple test positions is measured by the light sensor and recorded by the calculation module;
step s3: calculating the energy relationship curve between the galvanometer scanner's reflection angles and energy, wherein, the correspondence between the energy of the laser processing beam measured in step s2 and two corresponding reflection angles of the galvanometer scanner defines the energy relationship curve;
step s4: storing energy reference values at various positions to the database, wherein the energy of the laser processing beam and the two corresponding reflection angles of the galvanometer scanner in step s3 are stored to an energy relationship curve database.

3. The method as claimed in claim 2, wherein the multiple test positions landed by the laser processing beam are 17 test positions located within a scanning range of the galvanometer scanner, and the 17 test positions include a center point, eight inner loop points, and eight outer loop points.

4. The method as claimed in claim 3, wherein the galvanometer scanner includes a first scanning mirror and a second scanning mirror; the two reflection angles of the galvanometer scanner are a first reflection angle of the first scanning mirror and a second reflection angle of the second scanning mirror; and the first reflection angle and the second reflection angle are controlled by the console and the calculation module.

5. The method as claimed in claim 3, wherein the formula is as follows:
E_{S}=E*a*cos θ_{X}*b*cos θ_{Y}
where a and b are weights calculated by using θ_{X} as the difference between the corresponding first reflection angle of the center point and the corresponding first reflection angle of each of the eight outer loop points or the eight inner loop points respectively, and by using θ_{Y} as the difference between the corresponding second reflection angle of the center point 19 and the corresponding second reflection angle of each of the eight outer loop points or the eight inner loop points respectively.

6. The method as claimed in claim 1, wherein the laser processing machine further includes an objective lens, and the laser processing beam continuously passes through the beam splitter and the objective lens.

7. The method as claimed in claim 1, wherein the laser processing machine further includes an F-theta lens, and the laser processing beam continuously passes through the galvanometer scanner and the F-theta lens.

8. The method as claimed in claim 6, wherein the laser processing machine further includes an F-theta lens, and the laser processing beam continuously passes through the galvanometer scanner and the F-theta lens.

9. A dynamic spot size adjustment method for laser processing with an optical microscope, applied to a laser processing machine which includes a console, a calculation module, a galvanometer scanner, a vision module, a beam splitter, a laser source generating a laser beam, and a beam adjustment unit which further includes a beam expander for expanding the laser beam passing through the beam adjustment unit to form a laser processing beam, wherein after the laser processing beam passes through the galvanometer scanner and the beam splitter, the laser processing beam is focused on a plane; and the laser processing beam is controlled to scan the plane via the galvanometer scanner which is further controlled by the console and the calculation module, and the beam splitter guides a reflected laser processing beam to the vision module for measuring the spot size of the laser processing beam, and the dynamic spot size adjustment method for laser processing with optical microscope including the steps:
step s25: sample placement, wherein the sample is placed on the plane;
step s27: obtaining a spot size reference value from a database, wherein the calculation module reads a spot size relationship curve database;
step s28: various positions processing, wherein, based on a target processing position and the spot size relationship curve database, the calculation module finds the spot size of the laser processing beam corresponding to the target processing position, and uses said spot size as the spot size reference value of the laser processing beam at the target processing position, and then based on a target processing spot size for the target processing position and the spot size reference value corresponding to the target processing position, the calculation module determines an expansion value of the beam expander, and then issues a group of control commands to control the console, and then controls the expansion value of the beam expander via the console to adjust the spot size of the laser processing beam;
step s29: real time measuring laser processing beam spot size, wherein, the vision module senses the spot size image of the laser processing beam in real time, and thereby the calculation module determines the spot size of the laser processing beam in real time;
step s30: comparing measured value and reference value, wherein, the calculation module compares and confirms whether a relative percentage difference between the spot size of the laser processing beam measured in real time and the spot size reference value of the spot size relationship curve database is greater than a second threshold, and when said relative percentage difference is greater than the second threshold, go to the next step; otherwise skip the next step and go to the further next step;
step s31: real time spot size adjustment, wherein real time spot size adjustment is performed on the laser processing beam based on the spot size reference value from the spot size relationship curve database;
step s32: finishing processing, wherein the laser processing is completed.

10. The method as claimed in claim 9, further including the steps:
step s22: initial state measurement, wherein the spot size of the laser processing beam at each of multiple test positions is sensed by the vision module, and then recognized, measured, and recorded by the calculation module;
step s23: calculating the spot size relationship curve between the galvanometer scanner's reflection angles and spot size, wherein the correspondence between the spot size measured in step s22 and two reflection angles of the galvanometer scanner defines the spot size relationship curve;
step s24: storing spot size reference values at various positions to the database, wherein the spot size of the laser processing beam and the two corresponding reflection angles of the galvanometer scanner in step s23 are stored to a spot size relationship curve database.

11. The method as claimed in claim 10, wherein the multiple test positions landed by the laser processing beam are 17 test positions located within a scanning range of the galvanometer scanner, and the 17 test positions include a center point, eight inner loop points, and eight outer loop points.

12. The method as claimed in claim 10, wherein the galvanometer scanner includes a first scanning mirror and a second scanning mirror; the two reflection angles of the galvanometer scanner are a first reflection angle of the first scanning mirror and a second reflection angle of the second scanning mirror; and the first reflection angle and the second reflection angle are controlled by the console and the calculation module.

13. The method as claimed in claim 9, wherein the laser processing machine further includes an objective lens, and the laser processing beam continuously passes through the beam splitter and the objective lens.

14. The method as claimed in claim 9, wherein the laser processing machine further includes an F-theta lens, and the laser processing beam continuously passes through the galvanometer scanner and the F-theta lens.

15. The method as claimed in claim 13, wherein the laser processing machine further includes an F-theta lens, and the laser processing beam continuously passes through the galvanometer scanner and the F-theta lens.
